(19) United States
(12) Patent Application Publication
(10) Pub. No.: US 2015/0228126 A1
(43) Pub. Date: Aug. 13, 2015

(54) COMMUNICATION METHOD FOR A TOLLING SYSTEM COMPRISING A SERVER AND AT LEAST ONE ON-BOARD-UNIT

(71) Applicants: Calin CIMPEAN, Timisoara (RO); Doru ALDEA-UNGUREAN, Mosnita Noua (RO)

(72) Inventors: Calin CIMPEAN, Timisoara (RO); Doru ALDEA-UNGUREAN, Mosnita Noua (RO)

(73) Assignee: Continental Automotive GmbH

(21) Appl. No.: 14/617,403

(22) Filed: Feb. 9, 2015

(30) Foreign Application Priority Data
Feb. 10, 2014 (EP) 14464002

(51) Int. Cl. G07B 15/06; H04W 12/00

(52) U.S. Cl. CPC G07B 15/063; H04W 12/00

(57) ABSTRACT

A communication method for a tolling system having a server and at least one on-board-unit includes: predefining a message communication protocol comprising a predefined set of messages to be transmitted between the server and the on-board-unit; initializing a message format for each of the messages, the message format comprising a fixed length part and a variable length part with at least one status table; and assigning a multilevel security using at least two security levels attached to the messages and granted to the server and/or the on-board-unit.

### BACKGROUND OF THE INVENTION

1. Field of the Invention

The invention relates to the field of automotive applications. In particular, the invention relates to a communication method for a tolling system, a corresponding on-board-unit and a corresponding tolling system comprising the on-board-unit.

2. Description of the Related Art

US 2013/0096993 A1 describes a method of tolling vehicles in an open-road toll system with vehicle-based on-board units and roadside radio beacons. The described method includes transmitting transaction information and a factor from the on-board unit; updating the factor as a function of the transmitted transaction information and calculating a debit amount as a function of the updated factor; transmitting a debit request with the calculated debit amount and the updated factor to the on-board unit; and debiting the received debit amount to a toll credit account in the on-board unit and writing a new transaction information concerning this new debit transaction and the received updated factor into the on-board unit.

### SUMMARY OF THE INVENTION

It is an object of the invention to provide an improved tolling system.

According to a first aspect of the invention, a communication method for a tolling system comprising a server and at least one on-board-unit is provided, the method comprising the steps of: predefining a message communication protocol comprising a predefined set of messages to be transmitted between the server and the on-board-unit; initializing a message format for each of the messages, the message format comprising a fixed length part and a variable length part with at least one status table; and assigning a multilevel security using at least two security levels attached to the messages and granted to the server and/or the on-board-unit.

According to a further aspect of the invention, a on-board-unit for a tolling system is provided, the on-board-unit comprising: a predefining module adapted to predefine a message flow communication protocol comprising a predefined set of messages; an initializing module adapted to initialize a message format for each of the messages, the message format comprising a fixed length part and a variable length part with at least one status table; and an assigning module adapted to assign a multilevel security using at least two security levels attached to the messages and granted to the server and/or the on-board-unit.

According to a further aspect of the invention, a tolling system comprising a server and at least one on-board-unit is provided.

A basic idea of an aspect of the present invention uses a thin client solution and a communication between the server and the on-board-unit, OBU, wherein the communication is bi-directional, meaning that either one of this two devices can issue a message.

In order to provide a proper protocol for tolling requirements, a communication concept and a security concept is used.

An aspect of present invention advantageously provides a protocol that describes the information exchange between the OBU and the communication server based on TCP/IP transport protocol. The main advantage of TCP is that it assures the delivery of the transmitted data, and the sender can assume that the data was delivered.

Whenever a response message should be returned, the sender shall flag a pending state until the arriving of the answer for the previous request. If the pending state times out, the sender can retry or abort the request. However, no assumption on the result of the request or of the command can be taken. The number of retries and the threshold to abort the request is up to the application developer.

No message is sent before the arriving of previous messages acknowledge. Otherwise an acknowledge crossover could happen, leading to an uncertainty about the confirmation of a message.

An aspect of the present invention further provides an advanced security concept. A secure mechanism for data transfer between OBU and Server is provided.

Basically three topics are fulfilled in order to provide a secure mechanism: integrity, privacy, and authenticity.

According to an exemplary embodiment of the invention, the step of predefining the message communication protocol comprises flagging a pending state until an answer for a previous request is received. This advantageously allows a secure and fail-save mode of communication.

According to an exemplary embodiment of the invention, the step of predefining the message communication protocol comprises sending no message before a receiving of a receipt acknowledge of a previous message. This advantageously provides an improved reliability of the entire system.

According to an exemplary embodiment of the invention, the messages are transmitted via a general packet radio service or any other packet oriented mobile data service of a digital cellular networks system used by mobile phones. This advantageously allows using already present and established networks system.

According to an exemplary embodiment of the invention, the step of initializing the message format comprises using the fixed length part to define the common information for all data exchange.

According to an exemplary embodiment of the invention, the step of initializing the message format comprises using the variable length part to transmit data, commands and request groups.

According to an exemplary embodiment of the invention, as the predefined set of messages a firmware download, a message flow over TCP Transport Protocol, an acknowledge lost response, a response/ACK duplication, a protocol Initialization, or a GNSS fix lost protocol is used.

According to an exemplary embodiment of the invention, as the at least one status table a basic structure of data fields is used.

According to an exemplary embodiment of the invention, as the at least one status table an advanced structure of data fields is used.

According to another aspect of the invention, a program element is provided, which, when being executed on one or several processors of a navigation and communication system, instructs the system to perform the above and below described method steps.

According to another aspect of the invention, a non-transitory computer-readable medium is provided, on which the above described program element is stored.

A non-transitory computer-readable medium may be a floppy disk, a hard disk, a CD, a DVD, an USB (Universal Serial Bus) storage device, a RAM (Random Access Memory), a ROM (Read Only Memory) and an EPROM (Erasable Programmable Read Only Memory).

These and other aspects of the present invention will become apparent from and elucidated with reference to the embodiments described hereinafter.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the present invention will now be described in the following, with reference to the following drawings, in which:

FIG. 1 shows a schematic diagram of a tolling system comprising a server and three on-board-units according to an exemplary embodiment of the present invention;

FIG. 2 shows a schematic flow-chart diagram of a communication method for a tolling system according to an exemplary embodiment of the present invention;

FIG. 3 shows a schematic chart diagram of CRC computation according to an exemplary embodiment of the present invention;

FIG. 4 shows a schematic chart diagram of an encryption according to an exemplary embodiment of the present invention;

FIG. 5 shows a schematic chart diagram of an authentication concept according to an exemplary embodiment of the present invention;

FIG. 6 shows a schematic flow-chart diagram of a protocol initialization according to an exemplary embodiment of the present invention;

FIG. 7 shows a schematic flow-chart diagram of a firmware download protocol according to an exemplary embodiment of the present invention; and

FIG. 8 shows a schematic flow-chart diagram of a general format of the advanced status table according to an exemplary embodiment of the present invention.

### DETAILED DESCRIPTION OF THE PRESENTLY PREFERRED EMBODIMENTS

The accompanying drawings provide a schematic illustration. In different drawings, similar or identical elements or steps are provided with the same reference numerals.

The following detailed description is merely exemplary in nature and is not intended to limit application and uses.

Furthermore, there is no intention to be bound by any theory presented in the preceding background or summary or the following detailed description.

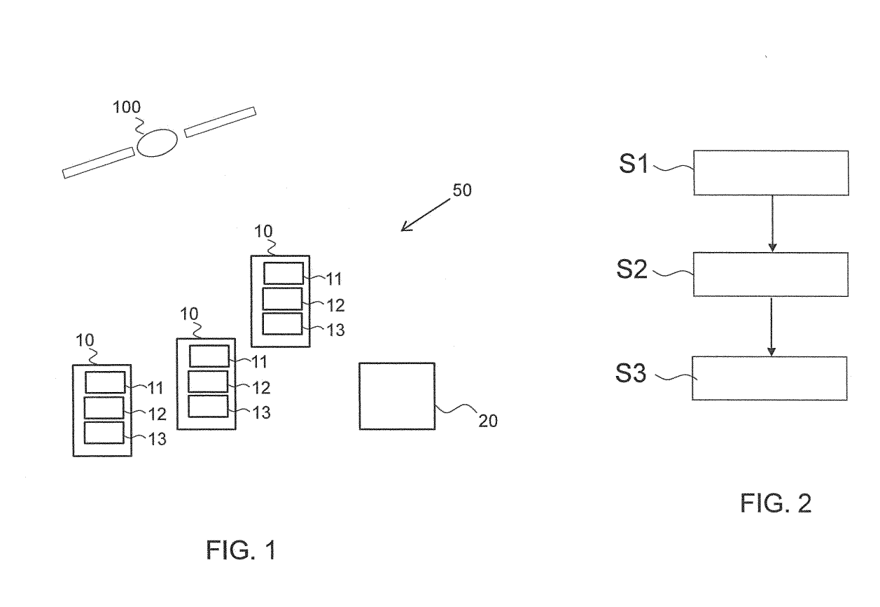

FIG. 1 shows a schematic diagram of a tolling system comprising a server and three on-board-units according to an exemplary embodiment of the present invention.

A tolling system 50 may comprise a server 20 and at least one on-board-unit 10; three on-board-units 10 are depicted in FIG. 1 and are located in different vehicles.

Each of the on-board-units may comprise a predefining module 11, an initializing module 12, and an assigning module 13.

The predefining module 11 may be adapted to predefine a message flow communication protocol comprising a predefined set of messages.

The initializing module 12 can be adapted to initialize a message format for each of the messages, the message format comprising a fixed length part and a variable length part with at least one status table.

The assigning module 13 may be adapted to assign a multilevel security using at least two security levels attached to the messages and granted to the server and/or the on-board-unit.

The on-board-unit 10 may be configured to receive navigational signals from a navigation satellite 100. The navigation satellite 100 may be assigned to a satellite navigation system or any other system of satellites that provide autonomous geo-spatial positioning with global coverage.

The on-board-unit 10 may be configured to determine their location (longitude, latitude, and altitude) to high precision (within a few meters) using time signals transmitted along a line of sight by radio from satellites. The signals also allow the electronic receivers to calculate the current local time to high precision, which allows time synchronization.

According to a further embodiment of the present invention, the status table is a message that carries the information generated or acquired from OBU to the Server. It will be sent: as a response for a request from the SERVER; when some event occurs; periodically for tracking purposes. Basically, there are two possible approaches for this message:

a fix table that is sent always in the same format no matter of the required information;

a configurable table from a pre-defined list of parameters that can be reconfigured to match the required information at that point.

The first option refers to a basic structure in form of a basic status table. The second one is referred to as an advanced status table, e.g., a status table with an advanced data structure.

The advanced status table has the following characteristics: Field length and identification codes. This basically provides two advantages:

If the application is not prepared to deal with the field code, it can disregard it and pass to the next field, without having to treat the unknown code.

The adding and creation of new fields is easier. Variable length of information fields Information fields may be included based on the occurrence of an event.

FIG. 2 shows a schematic flow-chart diagram of a communication method for a tolling system according to an exemplary embodiment of the present invention.

A communication method for a tolling system comprising a server and at least one on-board-unit, the method comprising the following steps:

As a first step of the method, predefining S1 a message communication protocol comprising a predefined set of messages to be transmitted between the server and the on-board-unit is performed.

As a second step of the method, initializing S2 a message format for each of the messages, the message format comprising a fixed length part and a variable length part with at least one status table is conducted.

As a third step of the method, assigning S3 a multilevel security using at least two security levels attached to the messages and granted to the server and/or the on-board-unit is conducted.

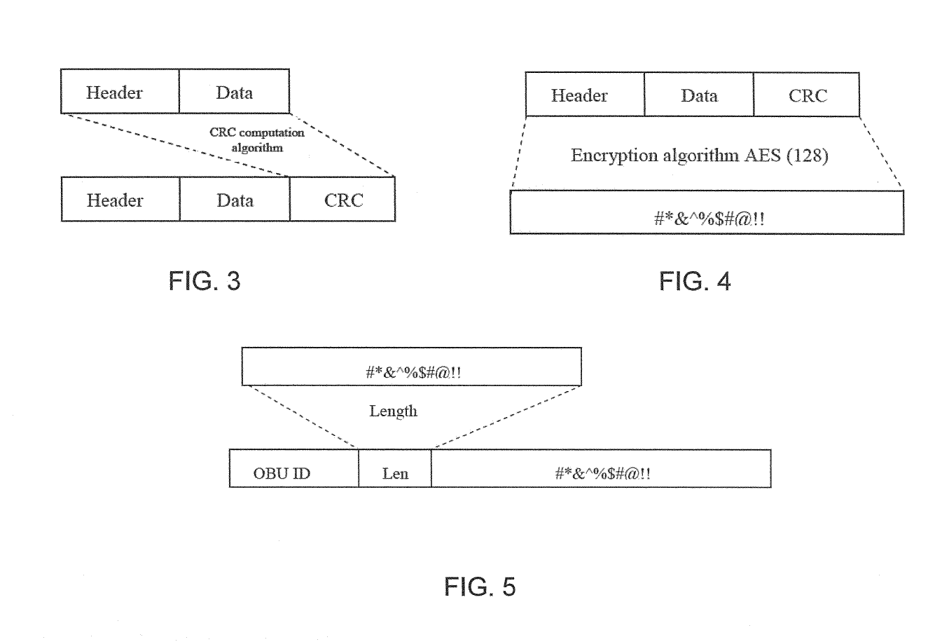

FIG. 3 shows a schematic chart diagram of CRC computation according to an exemplary embodiment of the present invention.

Because the communication protocol is a protocol designed for tolling purposes and deals indirectly with money the communication between OBU and Server needs to be secured. For this reason we need to provide a secure mechanism for data transfer between OBU and Server.

Basically there are three topics that need to be fulfilled, in order to provide a secure mechanism: integrity, privacy, and authenticity.

Integrity will be ensured by computing a CRC over the Message or the Command and adding the resulted 2 bytes at the end of the message/command, as shown in FIG. 3.

A cyclic redundancy check (CRC) is an error-detecting code commonly used in digital networks and storage devices to detect accidental changes to raw data. Blocks of data entering these systems get a short check value attached, based on the remainder of a polynomial division of their contents; on retrieval the calculation is repeated, and corrective action can be taken against presumed data corruption if the check values do not match.

CRCs are so called because the check (data verification) value is a redundancy (it adds no information to the message) and the algorithm is based on cyclic codes. CRCs are simple to implement in binary hardware, easy to analyze mathematically, and particularly good at detecting common errors caused by noise in transmission channels.

Because the check value has a fixed length, the function that generates it is occasionally used as a hash function. CRC is a reliable algorithm that has proved its effectiveness over time.

A CRC-16 is implemented as the particularity of this algorithm is that it will use a 17 bits polynomial length and the result will be on 2 bytes.

FIG. 4 shows a schematic chart diagram of an encryption according to an exemplary embodiment of the present invention.

The privacy will be ensured by encrypting the new resulted frame (header+data+CRC).

In cryptography, encryption is the process of encoding messages (or information) in such a way that eavesdroppers or hackers cannot read it, but that authorized parties can. In an encryption scheme, the message or information (referred to as plaintext) is encrypted using an encryption algorithm, turning it into an unreadable cipher text (ibid.). This is usually done with the use of an encryption key, which specifies how the message is to be encoded.

Any adversary that can see the cipher text should not be able to determine anything about the original message. An authorized party, however, is able to decode the cipher text using a decryption algorithm that usually requires a secret decryption key that adversaries do not have access to. For technical reasons, an encryption scheme usually needs a key-generation algorithm, to generate keys.

FIG. 5 shows a schematic chart diagram of an authentication concept according to an exemplary embodiment of the present invention.

Since a private-key encryption is used a mechanism for the key to be known to Server and OBU is needed, in other words a mechanism for the OBU to authenticate itself on the Server is needed. For this reason, a frame as shown in FIG. 5 is used.

After the encryption, the size of the encrypted part is known, so it is possible to construct the message frame. The message may have the following format, as depicted in FIG. 5:

OBU_ID (13 bytes);

encrypted message length (2 bytes);

encrypted message

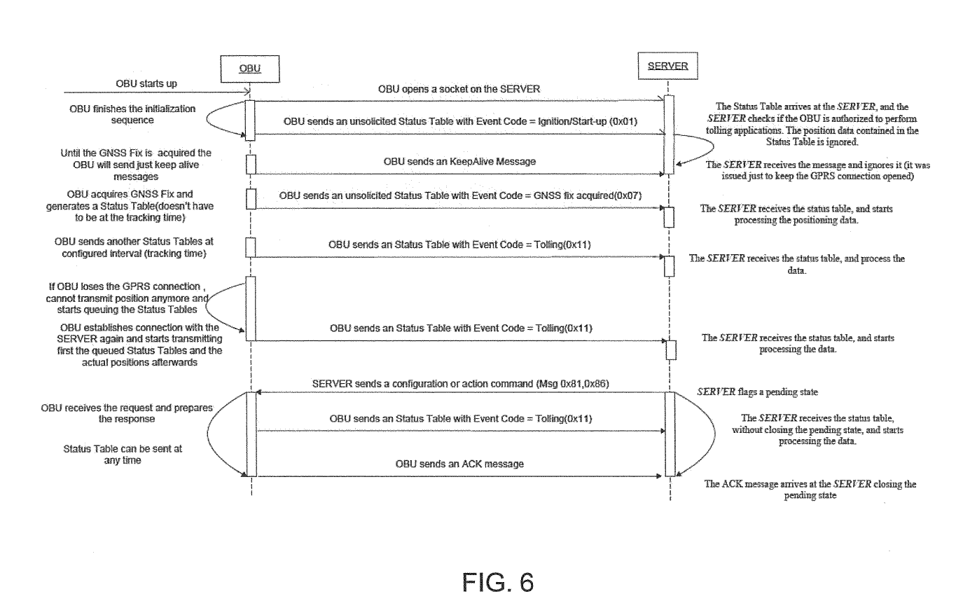

FIG. 6 shows a schematic flow-chart diagram of a protocol initialization according to an exemplary embodiment of the present invention.

At startup, after the socket is opened on the Server the OBU will send a Status Table to signal to the Server that the OBU is functional. Until the OBU will acquire the GNSS fix it will send only Keep Alive messages to the Server, if it does not have another command in-between. When the OBU will be able to obtain the GNSS fix it will issue another status table to the Server to signal the new state. After this Status Table will be send by the OBU to the Server at tracking time interval and the positioning data will be taken into account on Server side.

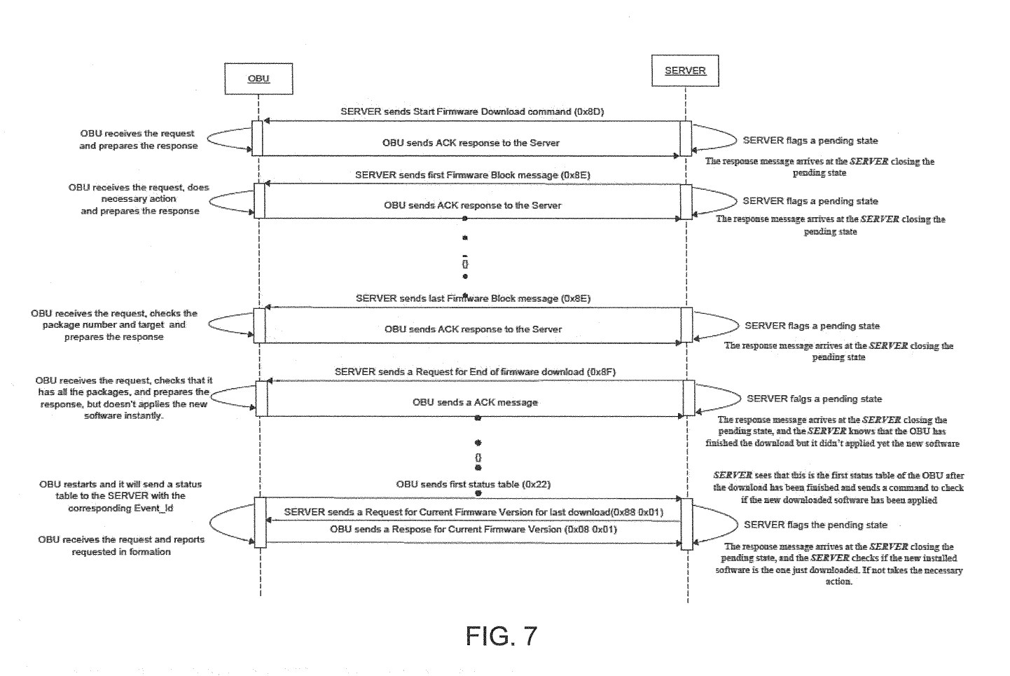

FIG. 7 shows a schematic flow-chart diagram of a firmware download protocol according to an exemplary embodiment of the present invention.

After a firmware download is finished the OBU will not apply the new software instantly, it will apply it at the next start-up therefore the Server, after the first status table will be generated by the OBU will have to send a 0x88 command to check if the new software has been applied or not.

According to a further embodiment (not shown), a further predefined message communication protocol may be constructed as follows:

In normal functioning mode of the OBU (GNSS Fix acquired and GPRS connection established) it is possible that the OBU can lose the GNSS Fix but still to have the GPRS connection available. In this case two scenarios are possible:

1) If the Status Table is configured to send just the positioning data the OBU will stop transmitting status tables until it will be able to obtain again the GNSS Fix or its status table it will be reconfigured to send some additional information.

2) If the Status Table has additional data configured to be sent, except for the positioning data, the OBU will continue to transmit the Status Table, but the positioning data will be filled with a default value that is recognized by Server as invalid.

According to a further not shown embodiment of the present invention, a further predefined message communication protocol may be constructed as follows:

For a firmware download, if a firmware download is in progress the status table can be received at any time by the server without any interference with the actual download process. Also any other command/s is/are allowed between 2 blocks transmission, however the Server should not send another Firmware Download command until the ACK arrives.

According to a further not shown embodiment, a further predefined message communication protocol may be constructed as follows:

For a firmware download, if the End Block message is lost, the OBU will not know if it can use the downloaded firmware. And if the ACK is not received by the Server, it cannot know if the new code will be used. For this reason, the End/ACK shall be completed.

According to a further not shown embodiment, a further predefined message communication protocol may be constructed as follows:

From the server's point of view, the loss of the response packet has the same effect as the loss of the request. So only the loss of the response message is shown. Also, the duplication of the request, from the point of view of the OBU, is the same as receiving two single requests. For this reason, critical requests that could not be executed more than once should have some mechanism to mark for uniqueness (e.g., Reading back the status of the changed configuration).

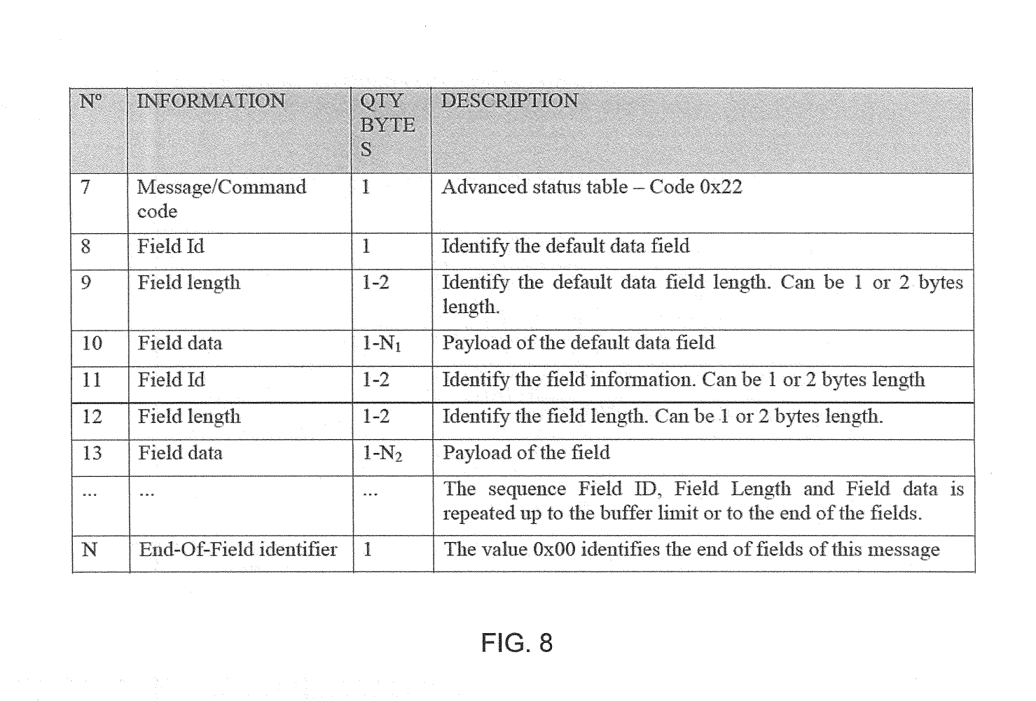

FIG. 8 shows a schematic flow-chart diagram of a general format of the advanced status table according to an exemplary embodiment of the present invention. The sequence Field ID, Field Length and Field data is repeated up to the buffer limit or to the end of the fields.

The status table is a structure of fields (bytes) that carries information to the Server.

The most significant bit of the first byte indicates whether or not there is a second byte. The most significant bit is discarded and should not be used as part of the field ID.

The data (may be except default status table) will be reported as it is represented in the OBU memory.

It should be noted that the term “comprising” does not rule out a plurality. It should further be noted that features described with reference to one of the above exemplary embodiments can also be used in combination with other features of other exemplary embodiments described above.

Moreover, while at least one exemplary embodiment has been presented in the foregoing summary and detailed description, it should be appreciated that a vast number of variations exist.

It should also be appreciated that the exemplary embodiment or exemplary embodiments are only examples, and are not intended to limit the scope, applicability, or configuration in any way.

Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A communication method for a tolling system having a server and at least one on-board-unit, the method comprising the steps of:
predefining (S1) a message communication protocol comprising a predefined set of messages to be transmitted between the server and the on-board-unit;
initializing (S2) a message format for each of the messages, the message format comprising a fixed length part and a variable length part with at least one status table; and
assigning (S3) a multilevel security using at least two security levels attached to the messages and granted to the server and/or the on-board-unit.

2. The communication method of claim 1, wherein the step of predefining (S1) the message communication protocol comprises flagging a pending state until an answer for a previous request is received.

3. The communication method of claim 1, wherein the step of predefining (S1) the message communication protocol comprises sending no message before a receiving of an receipt acknowledge of a previous message.

4. The communication method of claim 1, wherein the messages are transmitted via a general packet radio service or any other packet oriented mobile data service of a digital cellular networks system used by mobile phones.

5. The communication method of claim 1, wherein the step of initializing (S2) the message format comprises using the fixed length part to define the common information for all data exchange.

6. The communication method of claim 1, wherein the step of initializing (S2) the message format comprises using the variable length part to transmit data, commands and request groups.

7. The communication method of claim 1, wherein as the predefined set of messages a firmware download, a message flow over TCP Transport Protocol, an acknowledge lost response, a response/ACK duplication, a protocol Initialization, or a GNSS fix lost protocol is used.

8. The communication method of claim 1, wherein the method uses at least one status table having a basic structure of data fields.

9. The communication method of claim 1, wherein the method uses at least one status table having an advanced structure of data fields.

10. A non-transitory computer-readable medium storing a program, which, when being executed on one or several processors of a driver assistance system, instructs the system to perform the method steps of claim 1.

11. An on-board-unit (10) for a tolling system (50), the on-board-unit comprising:
a predefining module (11) configured to predefine a message flow communication protocol comprising a predefined set of messages;
an initializing module (12) configured to initialize a message format for each of the messages, the message format comprising a fixed length part and a variable length part with at least one status table; and
an assigning module (13) configured to assign a multilevel security using at least two security levels attached to the messages and granted to the server and/or the on-board-unit.

12. A tolling system (50) comprising: a server (20) and at least one on-board-unit (10) according to claim 11.
